(19) United States
(12) Patent Application Publication
(10) Pub. No.: US 2023/0257982 A1
(43) Pub. Date: Aug. 17, 2023

(54) MOTORIZED SYSTEM AND METHOD FOR CLEANING A TOILET BOWL

(71) Applicants: Olivia Murphy, Dallas, TX (US); Mila Bradford, Dallas, TX (US)

(72) Inventors: Olivia Murphy, Dallas, TX (US); Mila Bradford, Dallas, TX (US)

(21) Appl. No.: 17/651,305

(22) Filed: Feb. 16, 2022

(51) Int. Cl. E03D 9/03; E03D 9/00

(52) U.S. Cl. CPC E03D 9/037; E03D 9/002; E03D 2009/028

(57) ABSTRACT

A system for cleaning a toilet includes an electric motor, a splash guard, a first tank, a brush, and a first dispenser. The splash guard is coupled to the electric motor and configured to cover a bowl of a toilet. The splash guard comprises a seal configured to contact the toilet. The first tank is operable to store a first liquid cleaning agent. The brush is coupled to the electric motor and configured to contact the bowl of the toilet. The electric motor is configured to move the brush around the bowl of the toilet. The first dispenser is coupled to the first tank and operable to apply the first liquid cleaning agent to at least one from the set comprising: the brush and the bowl of the toilet.

### TECHNICAL FIELD

This disclosure relates generally to systems and methods for cleaning, and more specifically for cleaning toilets.

### BACKGROUND

Cleaning toilets is a manual process performed by a person using a conventional hand-held brush and cleaners. The conventional toilet cleaning process is slow, unsanitary, and often is unable to remove stains from the toilet due to the inability of the brush, cleaner, and/or person operating them to overcome stains in the toilet. Further, due in part to sanitary issues, toilet cleaning is often a disfavored task.

### SUMMARY OF THE DISCLOSURE

This disclosure contemplates a system for cleaning a toilet in which an electric motor is coupled to a splash guard. The splash guard covers the bowl of the toilet and has a seal for keeping water from leaving the toilet. The electric motor drives a brush configured to contact the bowl of the toilet. A liquid cleaning agent stored in a tank is dispensed and applied to either the brush or the bowl of the toilet to facilitate cleaning the toilet bowl. Certain embodiments are described below.

Certain embodiments of the present disclosure may provide one or more technical advantages.

In an embodiment of operation, a system for cleaning a toilet comprises: an electric motor; a splash guard coupled to the electric motor and configured to cover a bowl of a toilet, the splash guard comprising a seal configured to contact the toilet; a first tank operable to store a first liquid cleaning agent; a brush coupled to the electric motor and configured to contact the bowl of the toilet, wherein the electric motor is configured to move the brush around the bowl of the toilet; and a first dispenser coupled to the first tank and operable to apply the first liquid cleaning agent to at least one from the set comprising: the brush and the bowl of the toilet.

In another embodiment of operation, a method for cleaning a toilet comprises: covering, by a splash guard, a bowl of a toilet; contacting, by a seal coupled to the splash guard, the toilet; storing a first liquid cleaning agent in a first tank; moving, by an electric motor coupled to the splash guard, a brush around the bowl of the toilet, wherein the brush is coupled to the electric motor; contacting, by the brush, the bowl of the toilet; and applying, by a first dispenser coupled to the first tank, the first liquid cleaning agent to at least one from the set comprising: the brush and the bowl of the toilet.

In yet another embodiment of operation, a system for cleaning a toilet comprises: an electric motor; a splash guard coupled to the electric motor and configured to cover a bowl of a toilet, the splash guard comprising a seal configured to contact the toilet; a first tank operable to store a first liquid cleaning agent; a second tank operable to store a second liquid cleaning agent; a brush coupled to the electric motor; a first dispenser coupled to the first tank and operable to apply the first liquid cleaning agent to at least one from the set comprising: the brush and the bowl of the toilet; a second dispenser coupled to the second tank and operable to apply the second liquid cleaning agent to at least one from the set comprising: the brush and the bowl of the toilet; an actuating arm coupled to the brush, wherein the electric motor is coupled to the actuating arm and operable to rotate the actuating arm around the toilet bowl, wherein the actuating arm is operable to move to facilitate the brush contacting different portions of the bowl of the toilet, wherein the actuating arm is spring-loaded and telescoping to facilitate the brush contacting the bowl of the toilet, wherein the brush comprises different abrasiveness patterns, wherein the actuating arm is operable to move the brush to change the abrasiveness pattern of the brush that contacts the bowl of the toilet, and wherein the brush is operable to spin on the actuating arm; an optical sensor operable to detect stains on the bowl of the toilet; a processor communicatively coupled to the optical sensor and at least one from the set comprising the first dispenser and the second dispenser, the process configured to: receive signals from the optical sensor regarding the location of a detected stain on the bowl of the toilet; in response to the received signals from the optical sensor, communicate signals operable to move the brush to a selected abrasive pattern to contact the detected stain on the bowl of the toilet; in response to the received signals from the optical sensor, select between the first liquid cleaning agent and the second liquid cleaning agent; and in response to the received signals from the optical sensor, communicate signals operable to apply the selected of the first liquid cleaning agent and the second liquid cleaning agent to the detected stain; and a brush retraction button coupled to the splash guard, wherein the brush retraction button is operable to move the brush to an extended position when the brush is in a retracted position, and wherein the brush retraction button is operable to move the brush to the retracted position when the brush is in the extended position.

One advantage of the present disclosure is that the motorized toilet bowl cleaning system includes a splash guard seal coupled to the toilet bowl to prevent water spraying outside of the toilet bowl.

Another advantage allows for motorized application of a toilet brush to a toilet bowl to increase the cleaning power and cleaning speed over hand application of a toilet brush.

Yet another advantage allows for the motorized toilet bowl cleaning system to change one or more from the set comprising the abrasive pattern of the brush bristles and the liquid cleaning agent applied to the toilet depending on signals from an image sensor. A processor may use a closed-loop feedback system to determine the appropriate abrasive pattern of the brush bristles needed to clean the discoloration in the bowl. The toilet bowl cleaning system may include multiple liquid cleaning agents and may use a processor with a closed-loop feedback system to determine the appropriate liquid cleaning agent, or combination of liquid cleaning agents, to clean the discoloration in the bowl.

### BRIEF DESCRIPTION OF THE DRAWINGS

For a more complete understanding of the present disclosure reference is now made to the following description, taken in conjunction with the accompanying drawings, in which:

FIG. 1 illustrates an example system of the present disclosure;

FIG. 2 illustrates an example motorized toilet cleaner in the system of FIG. 1; and

FIG. 3 is a flowchart of a method for using the system of FIG. 1.

### DETAILED DESCRIPTION

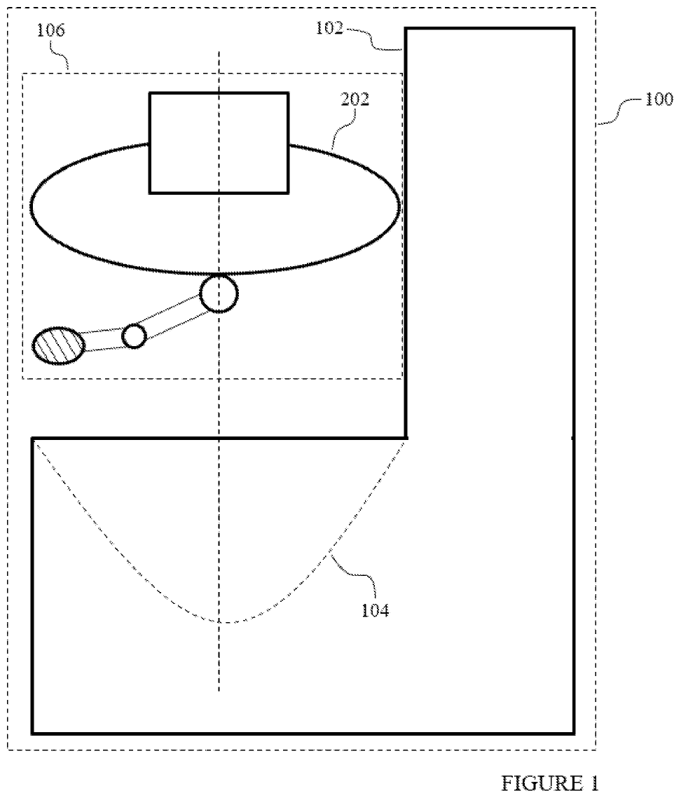

Embodiments of the present disclosure and its advantages are best understood by referring to FIGS. 1 through 3 of the drawings, like numerals being used for like and corresponding parts of the various drawings.

Toilet cleaning conventionally involves hand application of a brush to a toilet bowl by an individual. However, manual operation of toilet brushes may not sufficiently reach all surfaces of a toilet bowl, may not have sufficient force to clean certain stains from the toilet bowl, and may result in splashing or spillage of unsanitary water from the toilet bowl. This disclosure contemplates a motorized toilet cleaner positioned on top of a toilet bowl. The toilet cleaner may seal the toilet bowl by covering the toilet bowl with a splash guard in order to prevent splashing or spillage from escaping the toilet bowl during operation. The motorized toilet cleaner may include a brush which contacts the toilet bowl. The motorized toilet cleaner may include a motor which moves the brush around the toilet bowl. The brush may be attached to an actuating arm which enables the brush to contact various portions of the toilet bowl during operation. The brush may include a variety of bristle patterns to better facilitate cleaning of the toilet bowl.

The motorized toilet cleaner may also include a tank for storing a liquid cleaning agent. The liquid cleaning agent may be applied through a dispenser to at least the brush or the toilet bowl. The motorized toilet cleaner may further include an optical sensor that identifies stains on the toilet and communicates the location of detected stains to a processor. The processor may communicate signals operable to cause the motor to move the brush to the detected stain. The processor may further cause the dispenser to dispense the liquid cleaning agent from the tank. The processor may further cause the brush to move such that different abrasive patterns contact the stain on the toilet bowl.

A practical application of the motorized toilet cleaner is that the motorized toilet cleaner improves the cleaning of a toilet by using a motor to reduce the manual effort required and by covering the toilet bowl to eliminate splashing or spillage. The system will be described in more detail using FIGS. 1 through 3.

FIG. 1 illustrates an example environment 100. As seen in FIG. 1, environment 100 includes toilet 102, toilet bowl 104, and motorized toilet cleaning system 106. System 106 includes splash guard 202. Generally, motorized toilet cleaner 106 is positioned on top of toilet bowl 104 for cleaning toilet bowl 104 and the splash guard 202 covers the bowl to prevent escape of liquid from toilet bowl 104 during operation (e.g., cleaning).

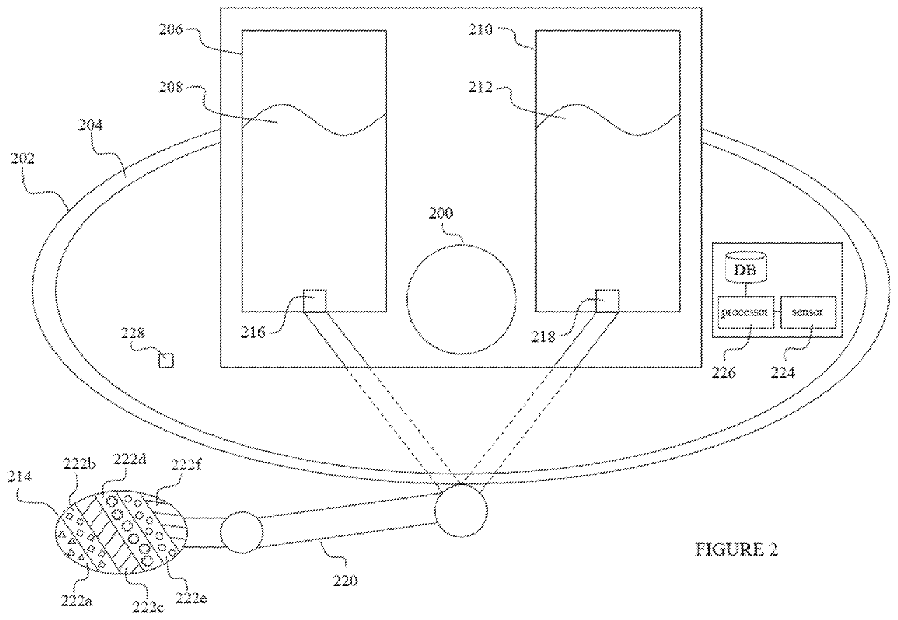

FIG. 2 illustrates an example motorized toilet cleaning system 106 of FIG. 1. Electric motor 200 may be coupled to splash guard 202. Splash guard 202 may cover toilet bowl 104 and may further include seal 204 which contacts toilet 102. Splash guard 202 and/or seal 204 may prevent splashing or spillage from escaping toilet bowl 104 during operation of system 106. Brush 214 may be coupled to electric motor 200 and configured to contact toilet bowl 104. Electric motor 200 may move brush 214 around toilet bowl 104. Tank 206 may store liquid cleaning agent 208, and tank 210 may store liquid cleaning agent 212. Dispenser 216 may be coupled to tank 206, and dispenser 218 is coupled to tank 210. Splash guard 202 may further include a brush retraction button 228. Brush 214 may include different abrasiveness patterns 222a, 222b, and 222c. Actuating arm 220 may be coupled to brush 214. Optical sensor 224 may be communicatively coupled to processor 226. Processor 226 may be further communicatively coupled to dispenser 216 and dispenser 218. Electric motor 200 may be operable to move brush 214 around toilet bowl 104 to facilitate cleaning toilet bowl 104.

In one embodiment, electric motor 200 is coupled to actuating arm 220, and electric motor 200 is operable to rotate actuating arm 220 around toilet bowl 104 so that brush 214 contacts different sections of toilet bowl 104. In another embodiment, electric motor 200 is operable to spin brush 214 on actuating arm 2202. Actuating arm 220 may further move to enable brush 214 to contact additional sections of toilet bowl 104. In a further embodiment, actuating arm 220 is spring-loaded and telescoping to allow brush 214 to contact the surface of toilet bowl 104 as actuating arm 220 pivots and moves around toilet bowl 104. In yet a further embodiment, brush 214 comprises different abrasiveness patterns 222a, 222b, and 222c. Actuating arm 220 may move brush 214 to change the abrasive pattern contacting toilet bowl 104.

In another embodiment, optical sensor 224 detects stains on toilet bowl 104. Processor 226 may receive signals from optical sensor 224 regarding the location of stains on toilet bowl 104. In response to signals from optical sensor 224, processor 226 may communicate signals to move brush 214 to contact the detected stain on toilet bowl 104. In another embodiment, processor 226 may select one from a set of abrasive patterns on brush 214 to contact a stain in response to signals from optical sensor 224. In certain embodiments, processor 226 may select an order of abrasive patterns to be applied to a stain in response to signals from optical sensor 224.

In a further embodiment, processor 226, in response to signals received from optical sensor 224, communicates signals to dispenser 216 to apply liquid cleaning agent 208. In one embodiment, liquid cleaning agent 208 may be applied to brush 214, while in another embodiment, liquid cleaning agent 208 may be applied to toilet bowl 104. In yet a further embodiment, processor 226, in response to signals received from optical sensor 224, selects between liquid cleaning agent 208 and liquid cleaning agent 212. Processor 226 may communicate signals to apply the selected liquid cleaning agent. In one embodiment, the selected liquid cleaning agent may be applied to brush 214, while in another embodiment, the selected liquid cleaning agent 208 may be applied to toilet bowl 104. In yet another embodiment, liquid cleaning agent 212 is stored in tank 210 and applied to the detected stain through dispenser 218.

In another embodiment, brush retraction button 228, in response to being pressed, moves brush 214 to an extended position when brush 214 is in a retracted position. Conversely, brush retraction button 228, in response to being pressed, moves brush 214 to a retracted position when brush 214 is in an extended position.

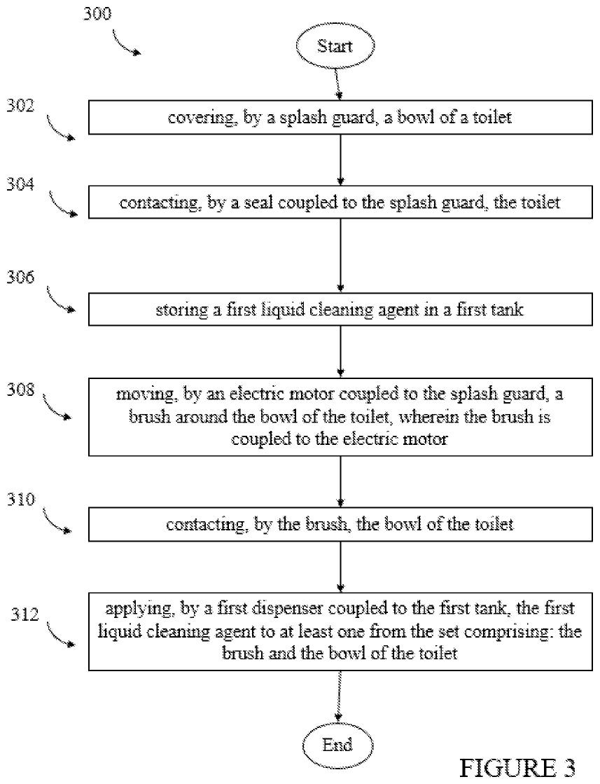

FIG. 3 is a flowchart illustrating a method 300 of cleaning toilet bowl 104 using the system 106 of FIG. 1. Generally, motorized toilet cleaner 106 performs the steps of method 300. In particular embodiments, by performing method 300, motorized toilet cleaner 106 cleans toilet bowl 104.

In step 302, splash guard 202 covers toilet bowl 104. Splash guard 202 prevents water or spillage from escaping toilet bowl 104. In step 304, seal 204 contacts toilet 102. In step 306, liquid cleaning agent 208 is stored in tank 206. In step 308, electric motor 200 moves brush 214 around toilet bowl 104. Electric motor 200 is coupled to splash guard 202, and brush 214 is coupled to electric motor 200. In step 310, brush 214 contacts toilet bowl 104. In step 312, dispenser 216 applies liquid cleaning agent 208 to at least one of brush 214 or toilet bowl 104. Modifications, additions, or omissions may be made to method 300 depicted in FIG. 3. Method 300 may include more, fewer, or other steps. For example, the steps may be performed in parallel or in any suitable order. While discussed as particular components of system 106 performing the steps, any suitable component of system 106 may perform one or more steps of the methods.

Although the present disclosure includes several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

1. A system for cleaning a toilet, the system comprising:
an electric motor;
a splash guard coupled to the electric motor and configured to cover a bowl of a toilet, the splash guard comprising a seal configured to contact the toilet;
a first tank operable to store a first liquid cleaning agent;
a second tank operable to store a second liquid cleaning agent;
a brush coupled to the electric motor;
a first dispenser coupled to the first tank and operable to apply the first liquid cleaning agent to at least one from the set comprising: the brush and the bowl of the toilet;
a second dispenser coupled to the second tank and operable to apply the second liquid cleaning agent to at least one from the set comprising: the brush and the bowl of the toilet;
an actuating arm coupled to the brush,
wherein the electric motor is coupled to the actuating arm and operable to rotate the actuating arm around the toilet bowl,
wherein the actuating arm is operable to move to facilitate the brush contacting different portions of the bowl of the toilet,
wherein the actuating arm is spring-loaded and telescoping to facilitate the brush contacting the bowl of the toilet,
wherein the brush comprises different abrasiveness patterns,
wherein the actuating arm is operable to move the brush to change the abrasiveness pattern of the brush that contacts the bowl of the toilet, and wherein the brush is operable to spin on the actuating arm;
an optical sensor operable to detect stains on the bowl of the toilet;
a processor communicatively coupled to the optical sensor and at least one from the set comprising the first dispenser and the second dispenser, the process configured to:
receive signals from the optical sensor regarding the location of a detected stain on the bowl of the toilet;
in response to the received signals from the optical sensor, communicate signals operable to move the brush to a selected abrasive pattern to contact the detected stain on the bowl of the toilet;
in response to the received signals from the optical sensor, select between the first liquid cleaning agent and the second liquid cleaning agent; and
in response to the received signals from the optical sensor, communicate signals operable to apply the selected of the first liquid cleaning agent and the second liquid cleaning agent to the detected stain; and
a brush retraction button coupled to the splash guard,
wherein the brush retraction button is operable to move the brush to an extended position when the brush is in a retracted position, and
wherein the brush retraction button is operable to move the brush to the retracted position when the brush is in the extended position.

2. A system for cleaning a toilet, the system comprising:
an electric motor;
a splash guard coupled to the electric motor and configured to cover a bowl of a toilet, the splash guard comprising a seal configured to contact the toilet;
a first tank operable to store a first liquid cleaning agent;
a brush coupled to the electric motor and configured to contact the bowl of the toilet, wherein the electric motor is configured to move the brush around the bowl of the toilet; and
a first dispenser coupled to the first tank and operable to apply the first liquid cleaning agent to at least one from the set comprising: the brush and the bowl of the toilet.

3. The system of claim 2, the system further comprising:
an actuating arm coupled to the brush,
wherein the electric motor is coupled to the actuating arm and operable to rotate the actuating arm around the bowl of the toilet, and
wherein the actuating arm is operable to pivot to facilitate the brush contacting different portions of the bowl of the toilet.

4. The system of claim 3, wherein the actuating arm is spring-loaded and telescoping to facilitate the brush contacting the bowl of the toilet.

5. The system of claim 3, wherein the brush comprises different abrasive patterns and wherein the actuating arm is operable to move the brush to change the abrasive pattern of the brush that contacts the bowl of the toilet.

6. The system of claim 5, wherein the brush is operable to spin on the actuating arm.

7. The system of claim 2, the system further comprising:
an optical sensor operable to detect stains on the bowl of the toilet;
a processor communicatively coupled to the optical sensor, the processor configured to:
receive signals from the optical sensor regarding the location of a detected stain on the bowl of the toilet; and
in response to the received signals from the optical sensor, communicate signals operable to move the brush to contact the detected stain on the bowl of the toilet.

8. The system of claim 6, wherein the processor is operable select an abrasive pattern of the brush to apply to the detected stain in response to the received signals from the optical sensor.

9. The system of claim 7, the system further comprising:
a second tank operable to store a second liquid cleaning agent; and
wherein the processor is further configured to:
select between the first liquid cleaning agent and the second liquid cleaning agent in response to the received signals from the optical sensor; and
communicate signals operable to apply the selected of the first liquid cleaning agent and the second liquid cleaning agent to the detected stain in response to the received signals from the optical sensor.

10. The system of claim 9, further comprising a second dispenser coupled to the second tank with the second liquid cleaning agent, and wherein the second liquid cleaning agent is applied through the second dispenser.

11. The system of claim 2, further comprising a brush retraction button coupled to the splash guard,
wherein the brush retraction button is operable to move the brush to an extended position when the brush is in a retracted position, and
wherein the brush retraction button is operable to move the brush to the retracted position when the brush in the extended position.

12. A method for cleaning a toilet, the method comprising:
covering, by a splash guard, a bowl of a toilet;
contacting, by a seal coupled to the splash guard, the toilet;
storing a first liquid cleaning agent in a first tank;
moving, by an electric motor coupled to the splash guard, a brush around the bowl of the toilet, wherein the brush is coupled to the electric motor;
contacting, by the brush, the bowl of the toilet; and
applying, by a first dispenser coupled to the first tank, the first liquid cleaning agent to at least one from the set comprising: the brush and the bowl of the toilet.

13. The method of claim 12, the method further comprising:
rotating, by the electric motor, an actuating arm around the bowl of the toilet, wherein the actuating arm is coupled to the electric motor; and
pivoting the actuating arm to facilitate the brush contacting different portions of the bowl of the toilet.

14. The method of claim 13, the method further comprising contacting, by the brush, the bowl of the toilet, wherein the actuating arm is spring-loaded and telescoping to facilitate the brush contacting the bowl of the toilet.

15. The method of claim 14, the method further comprising:
moving, by the actuating arm, the brush,
wherein the brush comprises different abrasive patterns, and
wherein moving the brush changes the abrasive pattern of the brush that contacts the bowl of the toilet.

16. The method of claim 15, the method further comprising spinning the brush on the actuating arm.

17. The method of claim 12, the method further comprising:
detecting, by an optical sensor, stains on the bowl of the toilet;
receiving, by a processor and from the optical sensor, signals regarding the location of a detected stain on the bowl of the toilet, wherein the processor is communicatively coupled to the optical sensor; and
communicating, by the processor and in response to the received signals from the optical sensor, signals operable to move the brush to contact the detected stain on the bowl of the toilet.

18. The method of claim 16, the method further comprising communicating, by the processor, signals operable to select an abrasive pattern of the brush to apply to the detected stain in response to the received signals from the optical sensor.

19. The method of claim 17, the method further comprising:
storing a second liquid cleaning agent in a second tank;
selecting, by the processor and in response to the received signals from the optical sensor, between the first liquid cleaning agent and the second liquid cleaning agent; and
communicating, by the processor and in response to the received signals from the optical sensor, signals operable to apply the selected of the first liquid cleaning agent and the second liquid cleaning agent to the detected stain.

20. The method of claim 19, the method further comprising applying the second liquid cleaning agent through a second dispenser coupled to the second tank with the second liquid cleaning agent.
